(19) United States
(12) Patent Application Publication
(10) Pub. No.: US 2008/0134532 A1
(43) Pub. Date: Jun. 12, 2008

(54) Triangular rule having magnifying device

(76) Inventor: Chin Lung Chen, Taichung (TW)

Correspondence Address: CHARLES E. BAXLEY, ESQ., 90 JOHN STREET, THIRD FLOOR, NEW YORK, NY, 10038, US

(21) Appl. No.: 11/635,121

(22) Filed: Dec. 6, 2006

(51) Int. Cl. B43L 7/00

(52) U.S. Cl. 33/488

(57) ABSTRACT

A triangular rule includes a rule member having two inclined surfaces, a groove and a longitudinal opening formed through one of the inclined surfaces, and a rod rotatably engaged into the groove of the rule member and rotatable relative to the rule member to any selected angular position. The rod includes three or more outer peripheral surfaces each having a marking for selectively aligning with the longitudinal opening of the rule member by rotating the rod relative to the rule member and for allowing the markings to be selectively seen by the users. A magnifying device may be attached to the rule member for magnifying the markings of the rod and the graduations of the rule member.

### BACKGROUND OF THE INVENTION

1. Field of the Invention

The present invention relates to a triangular rule, and more particularly to a triangular rule including a simplified structure for attaching a magnifying device to the triangular rule and for allowing the magnifying device to be easily moved relative to the triangular rule.

2. Description of the Prior Art

As shown in FIG. 1, the typical triangular rules 10 comprise a bottom flat surface 11 for resting on a flat working surface 12, and two upwardly directed surfaces 13 for forming an apex edge 14, and each of the surfaces 11, 13 containing a graduation or marking 15 adjacent the edges thereof and arranged for allowing the surfaces 11, 13 to be selectively faced upwardly and to be seen by the users or workers.

For example, U.S. Pat. No. 4,316,330 to Hayes discloses one of the typical triangular rules also comprising three faces or surfaces for forming a triangular structure and each containing a graduation or marking adjacent the edges thereof, and two of the faces or surfaces are upwardly directed surfaces for forming an apex edge, and a longitudinal groove centered in each of the faces or surfaces.

For allowing the graduations or markings of the typical triangular rules to be clearly seen by the users, a magnifying device have been developed and provided for slidably attaching to the triangular rule with a clamping device and for allowing the magnifying device to be moved laterally relative to or along the triangular rule.

However, the clamping device includes a complicated structure having a number of parts or elements for holding or carrying the magnifying device or for attaching the magnifying device to the triangular rule. The complicated clamping device may tilt the triangular rule relative to a flat working surface such that an additional stabilizing or support device is further required to be provided and attached to the triangular rule for engaging with the flat working surface and for preventing the triangular rule and the magnifying device to be tilted or fall from the flat working surface or for stabilizing the triangular rule.

The complicated clamping device and the triangular rule and the stabilizing or support device may include a complicated structure that may not be easily manufactured and assembled, and may include a large volme that is adverse for storing and transportation purposes.

The present invention has arisen to mitigate and/or obviate the afore-described disadvantages of the structures for the conventional triangular rules.

### SUMMARY OF THE INVENTION

The primary objective of the present invention is to provide a triangular rule including a simplified structure for attaching a magnifying device to the triangular rule and for allowing the magnifying device to be easily moved or adjusted relative to the triangular rule.

In accordance with one aspect of the invention, there is provided a triangular rule comprising a triangular rule member including a bottom surface for resting on a working surface, and two inclined surfaces for forming an apex edge, and a groove longitudinally formed therein and having a longitudinal opening formed through a first inclined surface of the inclined surfaces, and a rod rotatably engaged into the groove of the rule member and rotatable relative to the rule member to any selected angular position, the rod including a polygonal cross section having three or more surfaces formed in an outer peripheral portion thereof, and a marking provided on each of the surfaces of the rod, either of the markings of the rod being rotatable and selectively aligned with the longitudinal opening of the rule member by rotating the rod relative to the rule member.

The rule member includes a graduation provided on each of the inclined surfaces adjacent an edge of the rule member for allowing the graduations of the inclined surfaces to be seen by a user. The markings of the rod include a ratio different from that of the graduations of the rule member.

The rod includes at least one retaining ring attached thereto and engaged with the rule member for limiting the rod to rotate relative to the rule member and for preventing the rod from sliding relative to the rule member. The rod includes at least one peripheral recess formed therein for receiving the retaining ring.

The rod includes at least one cap attached thereto for allowing the rod to be rotated relative to the rule member by the user. A magnifying device may further be provided and attached to the rule member for magnifying the markings of the rod and the graduations of the rule member.

The magnifying device is attached to the rule member with an attaching device and includes a magnifying glass supported in an outer peripheral frame. The attaching device includes a post, the magnifying device includes an arm extended from the frame and pivotally coupled to the post.

The post includes a socket provided thereon, and the arm includes a pivotal coupler provided thereon and rotatably engaged into the socket of the post for pivotally coupling the arm to the post. The post includes a retaining device for slidably attaching to the rule member.

The rule member includes a channel formed therein for slidably receiving the retaining device of the post. The channel of the rule member is L-shaped. The channel of the rule member includes a longitudinal opening formed through a second inclined surface of the inclined surfaces of the rule member.

The retaining device of the post includes a slot formed between two spring legs which are engaged with the rule member for frictionally attaching or securing the post of the attaching device to the rule member and for positioning the post of the attaching device to the rule member at any selected position.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view illustrating one of the typical triangular rules;

FIG. 2 is a perspective view of a triangular rule in accordance with the present invention;

FIG. 3 is an exploded view of the triangular rule;

FIGS. 4, 5 are enlarged partial perspective views of the triangular rule;

FIG. 6 is a top plan schematic view illustrating the operation of the triangular rule;

FIG. 7 is a cross sectional view of the triangular rule taken along lines 7-7 of FIG. 2;

FIG. 8 is a partial cross sectional view of the triangular rule taken along lines 8-8 of FIG. 7; snf

FIG. 9 is a cross sectional view similar to FIG. 7, illustrating the operation of the triangular rule.

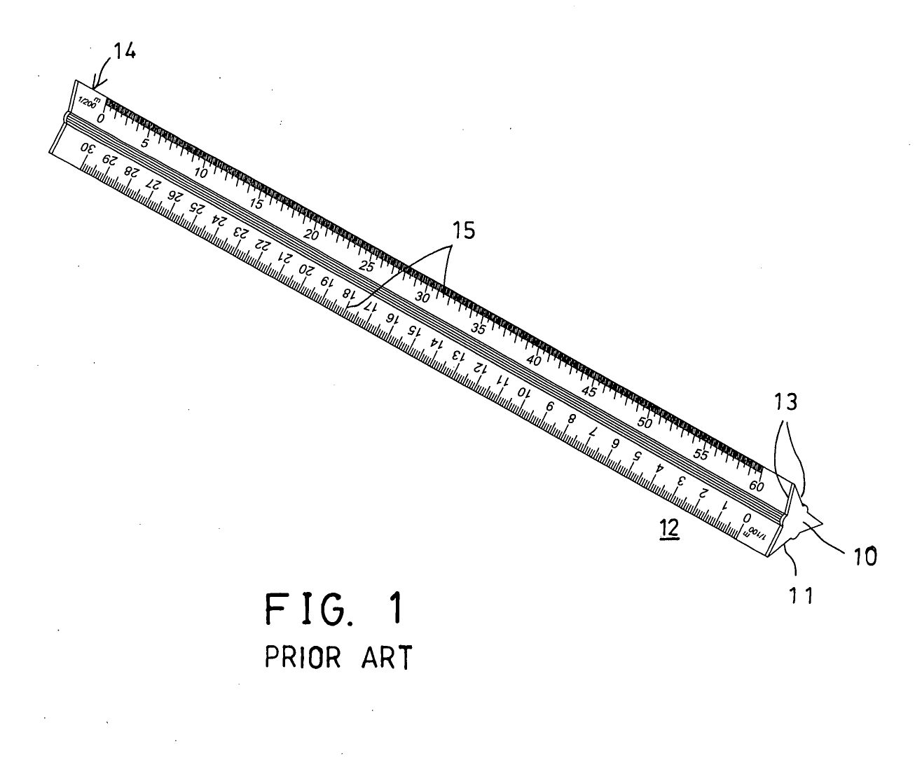

### DETAILED DESCRIPTION OF THE PREFERRED EMBODIMENT

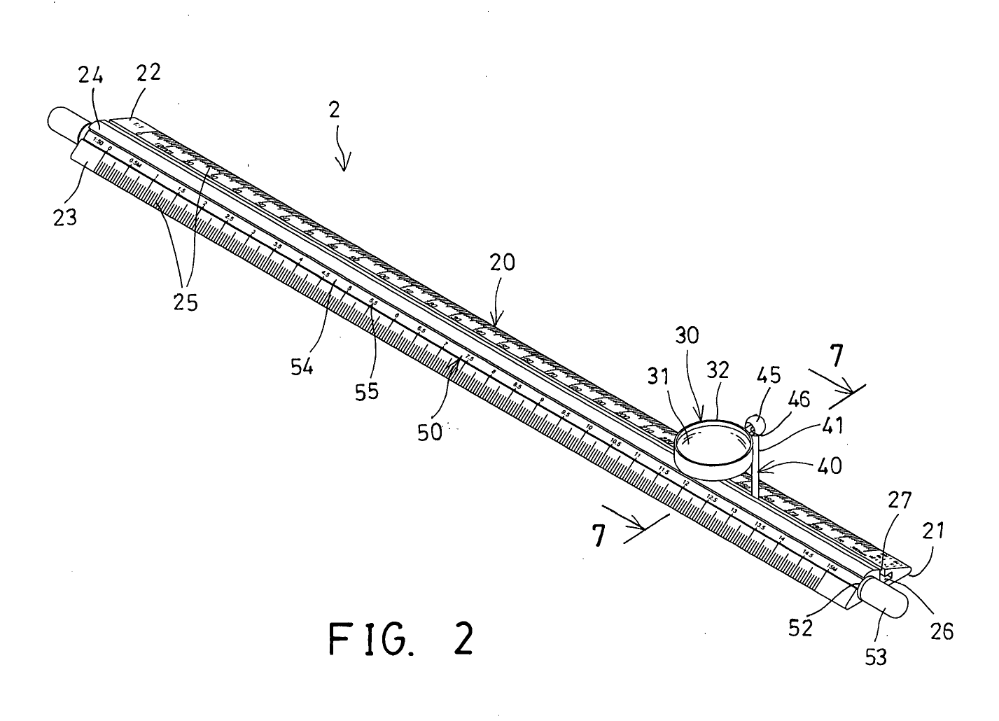

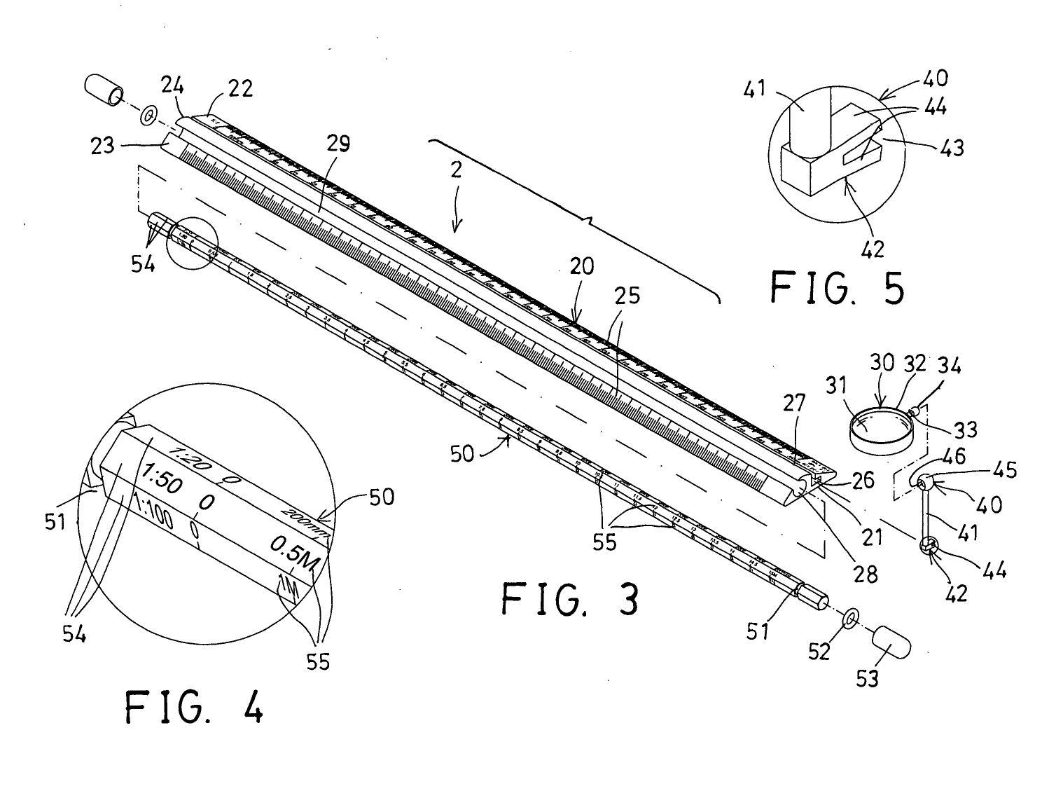

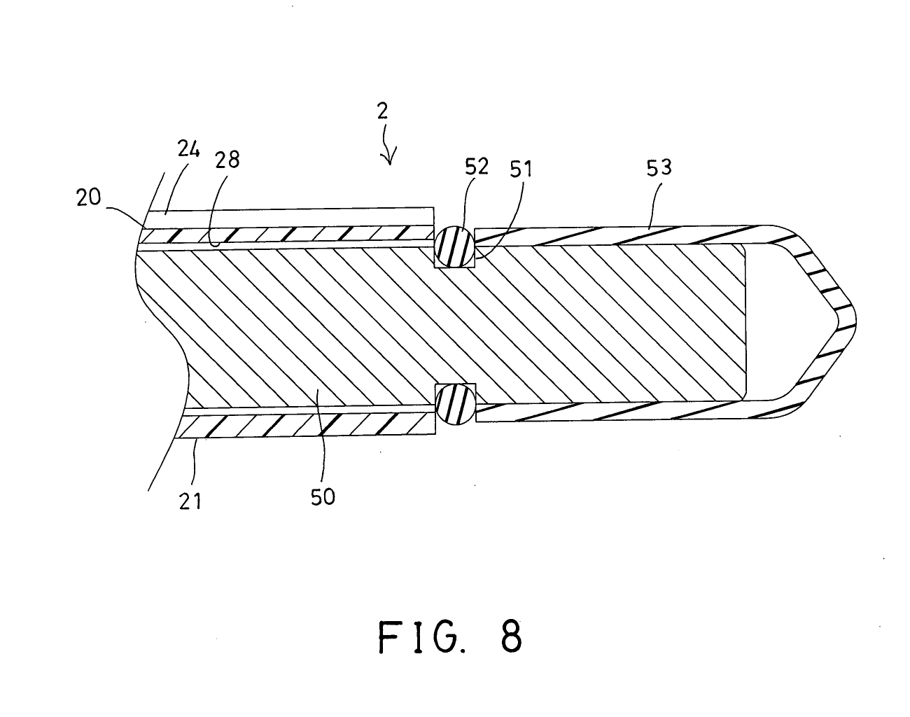

Referring to the drawings, and initially to FIGS. 2-7, a triangular rule 2 in accordance with the present invention comprises a triangular rule member 20 also including a bottom flat surface 21 (FIGS. 2-3, 7-8) for resting on a flat working surface 80, and two inclined or upwardly directed surfaces 22, 23 for forming an apex edge 24, and each of the inclined surfaces 22, 23 containing one or more graduations or markings 25 adjacent the edges thereof and arranged for allowing the inclined or upwardly directed surfaces 22, 23 to be seen by the users or workers. The rule member 20 includes an L-shaped channel 26 longitudinally formed therein, such as formed in one side and located below one of the inclined surfaces 22 and having a longitudinal opening 27 formed through the respective inclined surface 22.

The rule member 20 further includes a circular or cylindrical groove 28 longitudinally formed therein, such as formed in the other side and located below the other inclined surface 23 and having a longitudinal opening 29 formed through the respective inclined surface 23. A magnifying device 30 is attached to the rule member 20 with such as an attaching means or device 40 and includes a circular magnifying glass 31 attached or secured or supported in an outer peripheral frame 32, and an arm 33 extended from the frame 32 and having a spherical or ball member or pivotal coupler 34 formed or provided on the free end portion of the arm 33 for pivotally coupling to the attaching means or device 40 or for forming a universal joint or coupling device.

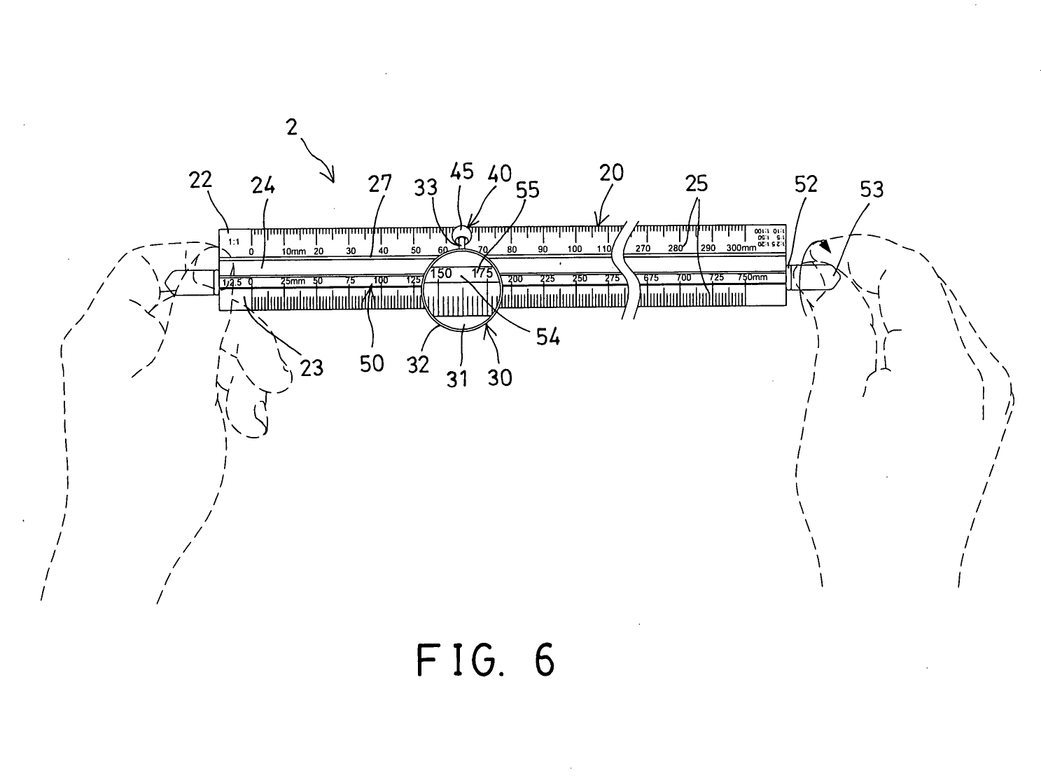

The attaching means or device 40 includes a post 41 having a lower retaining means or device 42 for slidably engaging into the channel 26 of the rule member 20 and for slidably attaching or securing the post 41 of the attaching means or device 40 to the rule member 20. For example, the retaining means or device 42 includes a slot 43 formed between two spring legs 44 (FIG. 5) which may be engaged with the rule member 20 for frictionally attaching or securing the post 41 of the attaching device 40 to the rule member 20 and for positioning the post 41 of the attaching device 40 to the rule member 20 at any selected position and for allowing the magnifying device 30 to be moved or adjusted relative to the graduations or markings 25 of the rule member 20 (FIGS. 2, 6).

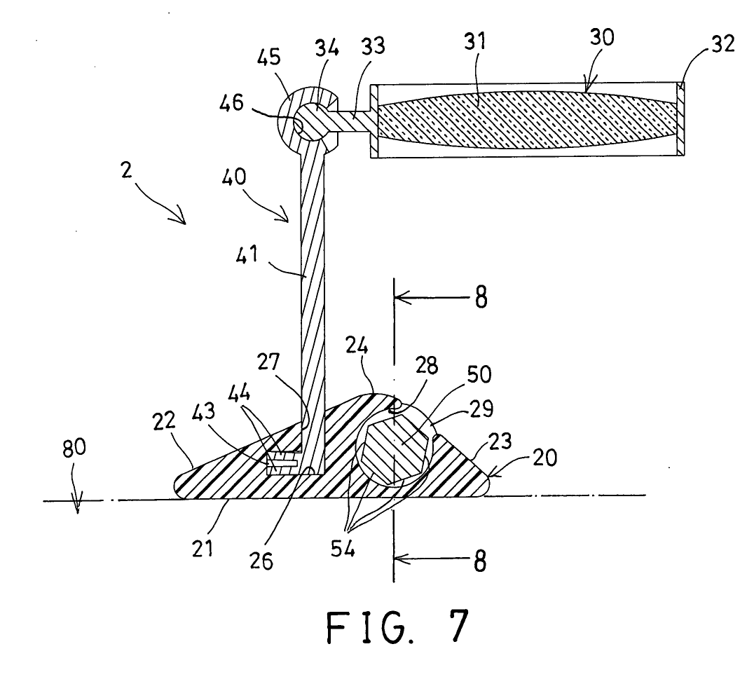

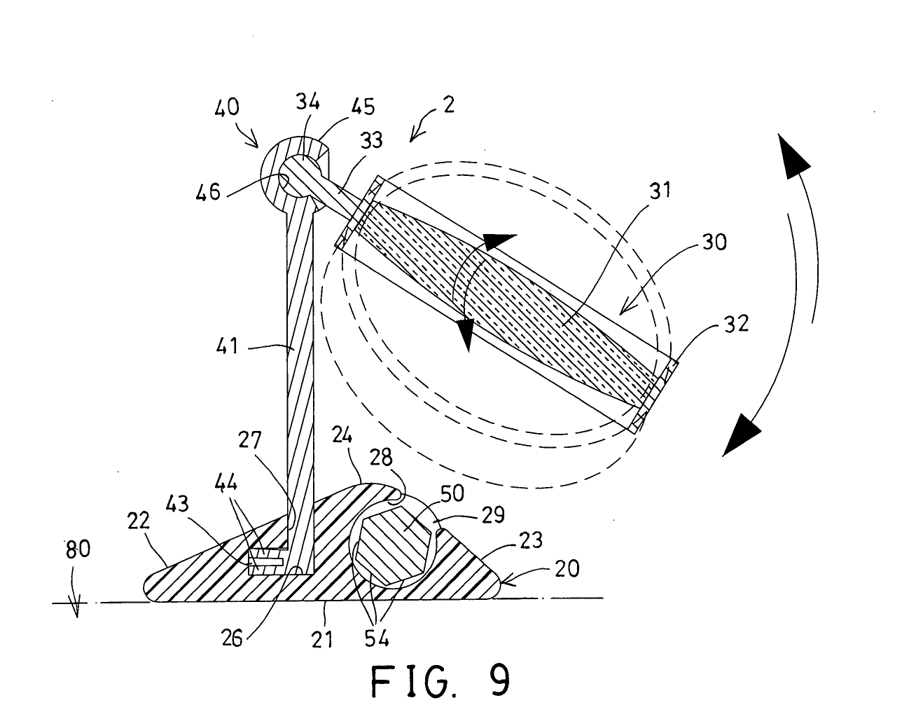

The attaching device 40 includes a socket 45 formed or provided on the other or free or upper end of the post 41 and having a socket opening 46 formed therein for receiving the pivotal coupler 34 of the post 41 and for pivotally and frictionally attaching or securing the magnifying device 30 to the post 41 of the attaching device 40 and for allowing the magnifying device 30 to be pivoted or adjusted relative to the post 41 to any selected angular position (FIGS. 7, 9) and also for allowing the magnifying device 30 to be suitably directed or faced toward the graduations or markings 25 of the rule member 20 and thus for allowing the graduations or markings 25 of the rule member 20 to be suitably read or seen through the magnifying device 30 (FIG. 6).

The rule member 20 further includes a longitudinal stem or shank or rod 50 pivotally or rotatably engaged into the groove 28 of the rule member 20 and arranged for allowing the rod 50 to be pivoted or rotated relative to the rule member 20 to any selected angular position (FIGS. 6-7, 9). The rod 50 includes a peripheral recess 51 formed in each of the two end portions of the rod 50 for engaging with a clamping or retaining ring 52 which may be engaged with the end portions of the rule member 20 (FIGS. 2, 6, 8) for limiting the rod 50 to rotate relative to the rule member 20 only and for preventing the rod 50 from sliding relative to the rule member 20. A cap 53 is attached onto each of the two end portions of the rod 50 for allowing the rod 50 to be suitably pivoted or rotated relative to the rule member 20 by the users.

It is preferable that the rod 50 includes a triangular or polygonal cross section having three or more surfaces 54 formed in the outer peripheral portion thereof (FIGS. 4, 7, 9), and a graduation or marking 55 formed or provided on each of the surfaces 54 of the rod 50 for aligning with either or all of the graduations or markings 25 of the rule member 20. It is further preferable that the graduations or markings 55 of the rod 50 include a ratio different from that of the graduations or markings 25 of the rule member 20, such as 1/10, 1/20, 1/50, 1/100, 1/200, 1/300, or the like best shown in FIGS. 4, 6. The surfaces 54 and/or the graduations or markings 55 of the rod 50 may thus be easily rotated and selectively aligned with the graduations or markings 25 of the rule member 20 by rotating the rod 50 relative to the rule member 20 without rotating the rule member 20 relative to the flat working surface 80 or other supporting surfaces. The magnifying device 30 may be provided for magnifying the graduations or markings 25, 55 of the rule member 20 and the rod 50.

In operation, as shown in FIG. 6, the rod 50 may be suitably pivoted or rotated relative to the rule member 20 by the users in order to align either of the surfaces 54 and/or the graduations or markings 55 of the rod 50 with the longitudinal opening 29 of the rule member 20 and thus for allowing either of the graduations or markings 55 of the rod 50 to be suitably aligned with the graduations or markings 25 of the rule member 20, and thus for allowing the graduations or markings 55 of the rod 50 and the graduations or markings 25 of the rule member 20 to be suitably read or seen through the magnifying device 30. The surfaces 54 and/or the graduations or markings 55 of the rod 50 may thus be easily and quickly rotated and selectively aligned with the graduations or markings 25 of the rule member 20 without rotating the rule member 20 relative to the flat working surface 80 or other supporting surfaces.

It is to be noted that the triangular rule 2 in accordance with the present invention includes a rule member 20, a magnifying device 30, an attaching device 40 and a rod 50 that may be easily and quickly assembled together and that may be easily detached or disengaged from each other for forming a compact folding or storing structure that is excellent for storing and transportation purposes.

Accordingly, the triangular rule in accordance with the present invention includes a simplified structure for attaching a magnifying device to the triangular rule and for allowing the magnifying device to be easily moved and adjusted relative to the triangular rule.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A triangular rule comprising:
a triangular rule member including a bottom surface for resting on a working surface, and two inclined surfaces for forming an apex edge, and a groove longitudinally formed therein and having a longitudinal opening formed through a first inclined surface of said inclined surfaces, and
a rod rotatably engaged into said groove of said rule member and rotatable relative to said rule member to any selected angular position, said rod including a polygonal cross section having at least three surfaces formed in an outer peripheral portion thereof, and a marking provided on each of said at least three surfaces of said rod, either of said markings of said rod being rotatable and selectively aligned with said longitudinal opening of said rule member by rotating said rod relative to said rule member.

2. The triangular rule as claimed in claim 1, wherein said rule member includes a graduation provided on each of said inclined surfaces adjacent an edge of said rule member for allowing said graduations of said inclined surfaces to be seen by a user.

3. The triangular rule as claimed in claim 2, wherein said markings of said rod include a ratio different from that of said graduations of said rule member.

4. The triangular rule as claimed in claim 1, wherein said rod includes at least one retaining ring attached thereto and engaged with said rule member for limiting said rod to rotate relative to said rule member and for preventing said rod from sliding relative to said rule member.

5. The triangular rule as claimed in claim 4, wherein said rod includes at least one peripheral recess formed therein for receiving said at least one retaining ring.

6. The triangular rule as claimed in claim 1, wherein said rod includes at least one cap attached thereto for allowing said rod to be rotated relative to said rule member by the user.

7. The triangular rule as claimed in claim 1, wherein a magnifying device is attached to said rule member for magnifying said markings of said rod and said graduations of said rule member.

8. The triangular rule as claimed in claim 7, wherein said magnifying device is attached to said rule member with an attaching device and includes a magnifying glass supported in an outer peripheral frame.

9. The triangular rule as claimed in claim 8, wherein said attaching device includes a post, said magnifying device includes an arm extended from said frame and pivotally coupled to said post.

10. The triangular rule as claimed in claim 9, wherein said post includes a socket provided thereon, and said arm includes a pivotal coupler provided thereon and rotatably engaged into said socket of said post for pivotally coupling said arm to said post.

11. The triangular rule as claimed in claim 9, wherein said post includes a retaining device for slidably attaching to said rule member.

12. The triangular rule as claimed in claim 11, wherein said rule member includes a channel formed therein for slidably receiving said retaining device of said post.

13. The triangular rule as claimed in claim 12, wherein said channel of said rule member is L-shaped.

14. The triangular rule as claimed in claim 12, wherein said channel of said rule member includes a longitudinal opening formed through a second inclined surface of said inclined surfaces of said rule member.

15. The triangular rule as claimed in claim 11, wherein said retaining device of said post includes a slot formed between two spring legs which are engaged with said rule member for frictionally attaching or securing said post of said attaching device to said rule member and for positioning said post of said attaching device to said rule member at any selected position.
